(19) United States
(12) Patent Application Publication
(10) Pub. No.: US 2022/0097003 A1
(43) Pub. Date: Mar. 31, 2022

(54) APPARATUS AND METHOD FOR SEPERATING TRITIATED AND HEAVY WATER FROM LIGHT WATER

(71) Applicant: HydroAtomics, LLC, Henderson, NV (US)

(72) Inventor: Boris Muchnik, Henderson, NV (US)

(21) Appl. No.: 17/449,084

(22) Filed: Sep. 27, 2021

Related U.S. Application Data
(60) Provisional application No. 63/083,429, filed on Sep. 25, 2020.

(51) Int. Cl. B01D 59/08; B01D 59/12; B01D 59/50; G21F 9/06

(52) U.S. Cl. CPC B01D 59/08; G21F 9/06; B01D 59/50; B01D 59/12

(57) ABSTRACT

An apparatus and method for separating tritiated water (HTO) and/or heavy water (D20) from light water (H2O). A disposable, dense, plastic filter mesh is disposed within a cylinder which is configured to rotate. Chilled heavy water is pumped into the rotating cylinder. Tritiated heavy water, which is preferably frozen, is pressed to the interior wall of the cylinder which is lined with the filter mesh. The heavy water becomes affixed to the mesh, and light water is drained from the cylinder to be reused as coolant. The mesh filter, when needed, is safely disposed in accordance with industry guidelines. The mesh filter is then replaced with a new iteration of the filter.

This is a nonprovisional utility patent application claiming priority to provisional patent application No. 63/083,429 filed on Sep. 25, 2020, and priority is claimed thereto.

### FIELD OF THE PRESENT INVENTION

The present invention relates to the field of nuclear power generation waste, and more specifically relates to an apparatus and method for separating tritiated water (HTO) and/or heavy water (D20) from light water (H₂O) through the use of a rotating cylinder equipped with a disposable, dense filter mesh disposed on an interior wall of the cylinder, configured to adhere to and therefore capture the HTO of the cooling water.

### BACKGROUND OF THE PRESENT INVENTION

Nuclear power plants must regularly contend with the disposal and storage of tritiated water. Traditionally the tritiated water is either stored in drums for 10 times its half-life (120 years) or it is dispersed into the local streams and environment, hopefully in small enough quantities to create a minimum of havoc on the local ecology, including the humans living in the area. However, it is believed by many that any amount of tritiated water is detrimental to living beings and that it is the primary source of cancer in today's society. Therefore, an alternate method of disposal of tritiated water is required.

Many other inventions deal with this subject matter and attempt to solve this problem. However none, before now, have been successful in creating a method that is both effective and economically feasible. For instance: U.S. Pat. No. 5,954,968, directed to an APPARATUS AND METHOD FOR SEPARATING HEAVY ISOTOPES OF HYDROGEN FROM HEAVY WATER issued on 1999 Sep. 21 by Patterson, James A. attempts to separate the heavy water from the light water by passing the mixture (heavy and light water mixed) through an elongated length of hollow core fiber which is formed of cellulose acetate, thereby attempting to filter out the heavy water. This method does, to some degree reduce the level of heavy water in the resulting mixture, but not to a great degree and the hollow fiber is thereafter no longer usable and must be discarded in an equally careful fashion as the original mixture. This of course creates a larger mass of substance which is contaminated with heavy water and which must be stored or discarded in some fashion.

U.S. Pat. No. 6,190,531, directed to CONCENTRATION AND REMOVAL OF TRITIUM AND/OR DEUTERIUM FROM WATER CONTAMINATED WITH TRITIUM AND/OR DEUTERIUM issued on 2001 Feb. 20 by Meyer, Thomas J ; Narula, Poonam M.; attempts to solve the problem by converting the HTO or HDO into an organic substrate, followed by electrolysis of said substrate while in the presence of metal oxo complexes thereby oxidizing the protioform of the substrate thereby creating hydrogen gas, and thereby concentrating the heavy isotopes in the water from which it can be subsequently removed. This method is complex, inefficient, expensive, not very effective and rather dangerous. The complexity and expense are of course tied together. It is dangerous because it places a radioactive substance into a gaseous pressurized form that can accidentally be let out into the atmosphere to the detriment of anyone down-wind. It is not very effective as it takes a considerable period of time to separate a small amount of the tritium or deuterium when there is a very large quantity that needs to be processed.

U.S. Pat. No. 6,153,092 APPARATUS FOR SEPERATING HEAVY IOSOTOPES OF HYDROGEN FROM WATER issued on 2000 Nov. 28 by Patterson, James A.; Gruber, Martin Josef; Furlong, Louis Edward; is similar to the prior patent except in that the hollow core fibers is filled or packed With small beads that are made up of porous exchange resin. It has all of the same disadvantages of as the prior patent.

U.S. Pat. No. 6,203,483 METHOD FOR SOLVENT EXTRACTION WITH NEAR-EQUAL DENSITY SOLUTIONS issued on 2001 Mar. 20 by Birdwell, Joseph F.; Randolph, John D.; Singh, S. Paul; is a method for the separation of liquids of near equal density using a modified centrifugal contractor with a means for creating a pressure differential between the inside of the rotor and the heavy phase solution outlet. This separation method will not separate heavy and light water, as when they are in the aqueous state their density is exactly the same.

U.S. Pat. No. 5,858,199 APPARATUS AND METHOD FOR ELECTROCORIOLYSIS THE SEPARATION OF IONIC SUBSTANCES FROM LIQUIDS BY ELECTROMIGRATION AND CORIOLIS FORCE issued on 1999 Jan. 12 by Hanak, Joseph J. is a method for separating ionizable compounds out of liquids, such as water, through the use of electromigration (electrolytic or electrostatic increasing the weight of the ionized substances) and thereby separating out said substances through the use of the Coriolis effect. This method has many similarities to the current invention in that it takes advantage of a natural process to increase the weight of a substance, which can then be more easily separated from the water. This method is of course ineffective for the separation of heavy water from light water in that the electrolytic and electrostatic affects only the chemical makeup of the mixture and does not affect the nuclear. It therefore is completely ineffective on a mixture of heavy and light water which when in an aqueous state act in the react in the same fashion to electricity.

U.S. Pat. No. 5,451,322 METHOD AND APPARATUS FOR TRITIATED WATER SEPARATION issued on 1995 Sep. 19 by Nelson, David A.; Duncan, James B.; Jensen, George A.; is a membrane method for separating heavy water from light water where the mixture is placed under pressured and forced through a polyphosphazene polymer based membrane. This method has the negative of being very expensive, very complicated (and therefore slow) and because the resulting reaction is exothermic can create a high-pressure system with all of its incumbent hazards.

U.S. Pat. No. 4,411,755 LASER-ASSISTED ISOTOPE SEPARATION OF TRITIUM issued on 1983 Oct. 25 Herman, Irving P., Marling, Jack B. catalytically reacting the heavy light Water mixture in an exchange reaction With XYD to produce XYT; irradiating said resulting mixture with a laser thereby dissociating the molecules to x+YT and then chemically separating the YT there from. It is costly, slow, and a high-pressure system and as such is dangerous and very complicated requiring expensive equipment.

The subject matter of Tritium Isotope Separation is discussed more fully in Dr. Gheorge Vasaru's book on the subject, which is incorporated herein by reference. The book discusses all of the above methods and is considered to be compendium of all knowledge on the subject to date. It is of course hoped and believed that the subject of this patent will merit a further chapter in his next update on the subject.

### SUMMARY OF THE PRESENT INVENTION

The present invention is an apparatus and method for separating tritiated water (HTO) and/or heavy water (D20) from light water (H2O). Water contaminated with tritium is produced as a by-product of nuclear power plants and is a substantial problem due to the detrimental effects of tritiated water on living organisms and the environment. The method of separation prescribed herein is intended to reduce the concentration of tritiated water in a volume of contaminated light water rather than fully separating the tritiated water from the light water.

The method involved is the simplest of methods and relies on the fact that tritiated water freezes at a different temperature than that of light water, i.e. the melting point of the tritiated water is higher than light water by 4.49 degrees Celsius, and when frozen, is of a different specific density than the light water. Simply put, when a mixture of the tritiated water and the light water is chilled to 4.49 degrees Celsius, the tritiated water will fall to the bottom of the mixture and freeze, allowing the light water to be easily drained or pumped into a second container.

From there, the system and apparatus of the present invention employs a spinning cylinder to force the heavier, frozen tritiated water to the circumferential sides of the cylinder. The cylinder is preferably composed of a disposable plastic, and exhibits a thick mesh interior to aid in the separation and capture of the frozen tritiated water to facilitate its removal from the cooling water of the system. The mesh is preferably configured to be easily removable from the cylinder when full such that it may be safely disposed and replaced.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 exhibits a view of the mesh and cylinder of the apparatus of the present invention as seen from the side.

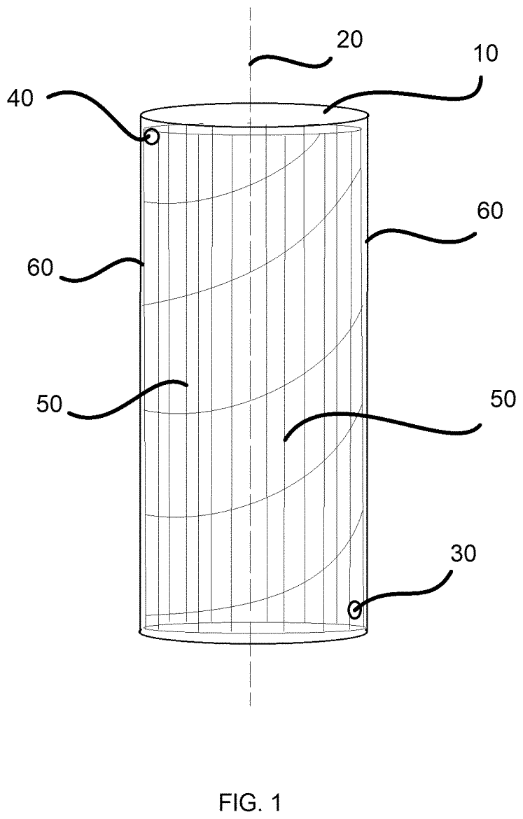

FIG. 2 shows a flow chart detailing the process of use of the present invention by a user in a nuclear power plant environment.

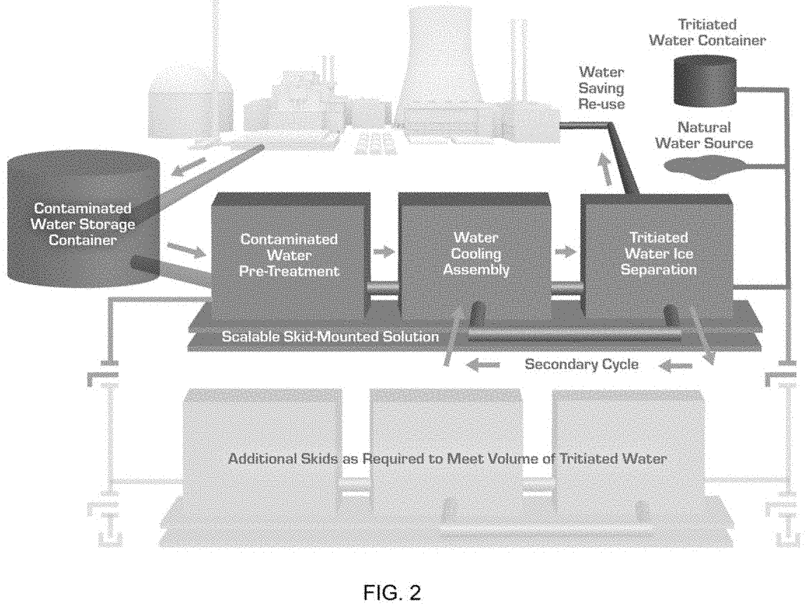

FIG. 3 shows a block diagram detailing the cooling system of the nuclear power plant, and the role in which the solution of the present invention is needed.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a Tritiated Water treatment apparatus and method configured to facilitate the treatment of contaminated water conventionally generated during nuclear power production. The preferred embodiment of the present invention is configured to continuously clean tritiated water (cooling water) on-site without the need to cease operations of the facility to undergo maintenance procedures.

The present invention employs the use of a cylinder (10) which is configured to rotate about a primary longitudinal axis (20). The cylinder (10) is preferably equipped with a drain (30) and intake (40). The drain (30) facilitates removal of the light water after it has been cleansed, and the intake (40) facilitates introduction of heavy water to the cylinder (10) via a pump. A filter mesh (50) is present along an interior side wall (60) of the cylinder (10). The filter mesh (50) is preferably composed of a dense plastic, and is disposable. It is envisioned that the filter mesh (50) may be easily removed via an access panel, or via the drain (30) when it must be disposed upon sufficient collection of tritiated water.

The system and apparatus of the present invention is configured to continuously clean tritiated water on-site without the need to shut down for maintenance. Once the declusterization of heavy and light water molecules is complete, the liquid is pumped into a chiller. The chiller cools the water to two to four degrees Celsius prior to being introduced to the cylinder (10) of the present invention. The cylinder (10) then rotates per a connection to at least one motor disposed adjacent to the cylinder (10). As the cylinder rotates, the tritiated water becomes attached to the filter mesh (50) of the interior side wall (60). Occasionally, the filter mesh (50) is removed and replaced with a new filter mesh (50).

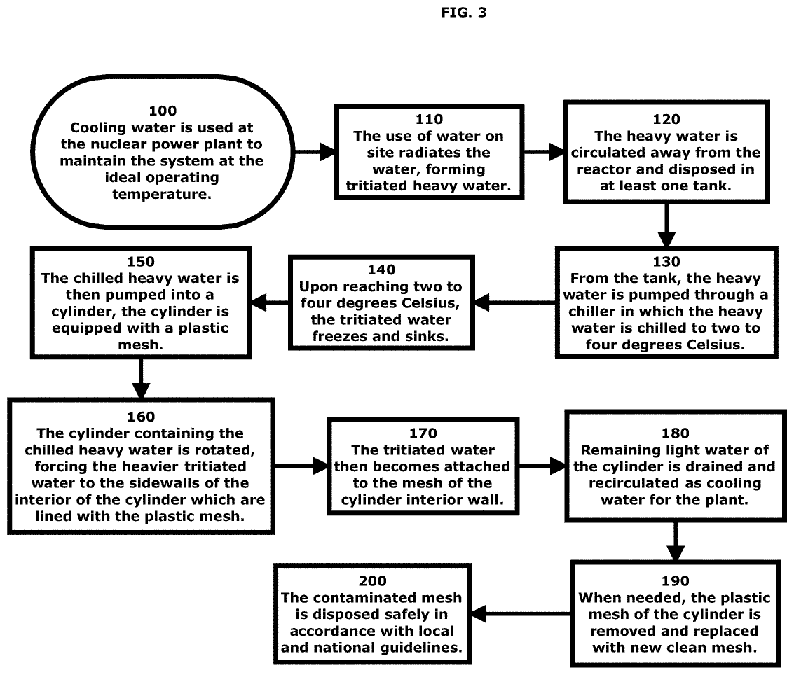

The process of installation and use of the system and apparatus of the present invention, as shown in FIG. 3, is preferably as follows:
1. Cooling water is used at the nuclear power plant to maintain the system at the ideal operating temperature. (100)
2. The use of water on site radiates the water, forming tritiated heavy water. (110)
3. The heavy water is circulated away from the reactor and disposed in at least one tank. (120)
4. From the tank, the heavy water is pumped through a chiller in which the heavy water is chilled to two to four degrees Celsius. (130)
5. Upon reaching two to four degrees Celsius, the tritiated water freezes and sinks. (140)
6. The chilled heavy water is then pumped into a cylinder, the cylinder is equipped with a plastic mesh. (150)
7. The cylinder containing the chilled heavy water is rotated, forcing the heavier tritiated water to the sidewalls of the interior of the cylinder which are lined with the plastic mesh. (160)
8. The tritiated water then becomes attached to the mesh of the cylinder interior wall. (170)
9. Remaining light water of the cylinder is drained and recirculated as cooling water for the plant. (180)
10. When needed, the plastic mesh of the cylinder is removed and replaced with new clean mesh. (190)
11. The contaminated mesh is disposed safely in accordance with local and national guidelines. (200)

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An apparatus for separating tritiated water from light water, comprising:
a cylinder;
a drain, in communication with said cylinder;
an intake, in communication with said cylinder;
a pump, in communication with said intake; and
a filter mesh, in communication with said cylinder.

2. The apparatus of claim 1, wherein said cylinder is configured to rotate about a primary longitudinal axis.

3. The apparatus of claim 1, wherein said drain is configured to remove light water after cleansing.

4. The apparatus of claim 1, wherein said intake is configured to introduce tritiated water into said cylinder from said pump.

5. The apparatus of claim 1, wherein said filter mesh is disposed within said cylinder.

6. A method for separating tritiated water from light water, comprising:
pumping heavy water through a chiller;
chilling the heavy water to 2 to 4 degrees Celsius;
allowing the chilled heavy water to sink;
pumping the chilled heavy water into a cylinder; and
attaching the chilled heavy water to plastic mesh inside the cylinder.
